(19) United States
(12) Patent Application Publication
(10) Pub. No.: US 2024/0213788 A1
(43) Pub. Date: Jun. 27, 2024

(54) CHARGING DEVICE

(71) Applicant: SPEED TECH CORPORATION, Taoyuan City (TW)

(72) Inventors: Chun-Te Liu, Taoyuan City (TW); Sheng-Ti Yang, Taoyuan City (TW); Hsuan-Ju Liu, Taoyuan City (TW); Kuo-Wei Chen, Taoyuan City (TW); Yu-Min Cheng, Taoyuan City (TW)

(73) Assignee: SPEED TECH CORPORATION, Taoyuan City (TW)

(21) Appl. No.: 18/196,483

(22) Filed: May 12, 2023

(30) Foreign Application Priority Data
Dec. 21, 2022 (TW) 111149314

(51) Int. Cl. H02J 7/00; H05B 1/02

(52) U.S. Cl. CPC H02J 7/0044; H05B 1/023

(57) ABSTRACT

A charging device includes a base, a charging assembly, a filler, and a drain assembly. The base includes a charging groove and a receiving groove. The charging groove has a first opening and a second opening. The first opening has a first through hole. The receiving groove has a second through hole. The charging assembly is connected to the second opening. The filler is connected to an inner side of the first opening and disposed close to the first through hole, and has a connecting opening. Two ends of the drain assembly are connected to the first through hole and the second through hole respectively. The inner side of the first opening has a first distance, an inner side of the connecting opening has a second distance, and the first distance is greater than the second distance.

### CROSS-REFERENCE TO RELATED APPLICATION

This non-provisional application claims priority under 35 U.S.C. § 119(a) to Patent Application No. 111149314 filed in Taiwan, R.O.C. on Dec. 21, 2022, the entire contents of which are hereby incorporated by reference.

### BACKGROUND

### Technical Field

The present invention relates to a charging device, and in particular, to a charging device having a filler, a first through hole, and a second through hole and realizing drainage through the filler, the first through hole, and the second through hole.

### Related Art

Electronic devices are developing in the trend of miniaturization and portability, and increasing electronic devices are designed as portable devices that can be energized without a plug. However, such portable electronic devices usually rely on power supply by batteries. When a battery capacity is insufficient, a user needs to charge the electronic devices (for example, with a charging stand). When the electronic devices are operated and charged at a room temperature, the electronic devices usually can be normally charged through the charging stand. However, when the electronic devices are used in a low-temperature operating environment and the charging stand is arranged in a room-temperature operating environment, transferring the electronic devices from the low-temperature environment to the room-temperature environment causes a temperature difference, which gradually condenses water into water droplets on surfaces of the electronic devices with a relatively low temperature. The water droplets flow to the charging stand along the surfaces of the electronic devices. During charging by the charging stand, the water vapor or the water droplets cause electrolysis of an electroplated layer of a terminal of the charging stand, which accelerates metal oxidation, resulting in a charging failure or abnormality of the terminal of the charging stand.

### SUMMARY

In view of the above, in some embodiments, a charging device includes a base, a charging assembly, a filler, and a drain assembly. The base includes a charging groove and a receiving groove. The charging groove has a first opening and a second opening. The first opening has a first through hole. The receiving groove has a second through hole. The charging assembly is connected to the second opening. The filler is connected to an inner side of the first opening and disposed close to the first through hole, and has a connecting opening. Two ends of the drain assembly are connected to the first through hole and the second through hole respectively. The inner side of the first opening has a first distance, an inner side of the connecting opening has a second distance, and the first distance is greater than the second distance.

In some embodiments, the first through hole has a horizontal line, and the filler has an axis parallel to the horizontal line.

In some embodiments, the first through hole includes an inlet and an outlet, the inlet is located on one side of the horizontal line, and the outlet is located on an other side of the horizontal line.

In some embodiments, the inlet includes a first endpoint and a second endpoint, and the filler is adjacent to the second endpoint.

In some embodiments, a center of the charging assembly includes a plumb line, the first endpoint is at a third distance from the plumb line, the second endpoint is at a fourth distance from the plumb line, and the third distance is greater than or equal to the fourth distance.

In some embodiments, an inner side of the charging groove includes an assembly groove, the assembly groove is adjacent to the first through hole, and the filler is assembled into the assembly groove and protrudes from the assembly groove.

In some embodiments, the charging device further includes a sensor, where the sensor is located between the filler and the second opening and coupled to the charging assembly, and is configured to generate a start signal when sensing a first humidity value and generate an end signal when sensing a second humidity value. The charging assembly is configured to stop charging according to the start signal and to resume charging according to the end signal.

In some embodiments, the charging device further includes a heating assembly, where the heating assembly is located between the filler and the second opening and coupled to the sensor, and is configured to perform a heating action according to the start signal and to stop the heating action according to the end signal.

In some embodiments, a first partition wall and a second partition wall respectively extend from two ends of the first opening, the first partition wall has a first guiding surface, the second partition wall has a second guiding surface, and the first guiding surface and the second guiding surface respectively face the first opening.

In some embodiments, two sides of the first partition wall each include a first side plate group, two sides of the second partition wall each include a second side plate group, and the first side plate group and the second side plate group respectively extend along two sides of the first opening.

In some embodiments, the first opening has a third through hole, the third through hole is located on an opposite side of the first through hole, one end of the drain assembly is connected to the first through hole and the third through hole, and an other end is connected to the second through hole.

In some embodiments, the drain assembly includes a first drain unit and a second drain unit, the receiving groove includes a fifth through hole, one end of the first drain unit is connected to the first through hole, an other end is connected to the second through hole, one end of the second drain unit is connected to the third through hole, and an other end is connected to the fifth through hole.

In some embodiments, the first through hole has a horizontal line, the filler has an axis parallel to the horizontal line, the axis intersects and forms an included angle with the horizontal line, a side of the filler is adjacent to the first through hole, and the included angle is an acute angle.

Based on the above, according to some embodiments, in the charging device, through the filler and the first through hole located in the charging groove, a water droplet can be prevented from flowing to the charging assembly by the filler, and the filler can guide the water droplet to flow to the first through hole and be discharged outside of the base of the charging device through the second through hole, which ensures that the charging assembly does not contact the water droplet, thereby maintaining normal charging of the charging assembly.

Detailed features and advantages of the present invention are described in detail in the following implementations, which are sufficient for any person skilled in the art to understand the technical content of the present invention and implement the operations accordingly. According to the content disclosed in this specification, the scope of the patent application, and the drawings, any person skilled in the art can easily understand related objectives and advantages of the present invention.

### BRIEF DESCRIPTION OF THE DRAWINGS

FIG. 1 is a three-dimensional view of a charging device according to some embodiments of the present invention.

FIG. 2 is a cross-sectional view of FIG. 1 in a direction A-A.

FIG. 3 is a front view of an electronic device connected to a charging device according to some embodiments of the present invention.

FIG. 4 is a side cross-sectional view of FIG. 1 in the direction A-A, showing a schematic diagram of the electronic device connected to a base.

FIG. 5 is an enlarged view of a region 5 in FIG. 2, showing a distance between two sides of a first opening and a distance between two sides of a filler.

FIG. 6 is an enlarged view of the region 5 in FIG. 2, showing a schematic diagram of distances of a first endpoint and a second endpoint from a plumb line.

FIG. 7 is a cross-sectional view of the electronic device in a direction B-B in FIG. 1 according to some embodiments of the present invention, showing positions of a sensor and a heating assembly in a charging groove.

FIG. 8 is a cross-sectional view of the charging device in the direction A-A in FIG. 1 according to some embodiments of the present invention, showing relatives position of a first through hole and a third through hole.

FIG. 9 is a cross-sectional view of the charging device in the direction A-A in FIG. 1 according to some embodiments of the present invention, showing relative positions of a first drain unit and a second drain unit.

FIG. 10 is a cross-sectional view of the charging device in the direction A-A in FIG. 1 according to some embodiments of the present invention, showing an included angle between an axis and a horizontal line.

### DETAILED DESCRIPTION

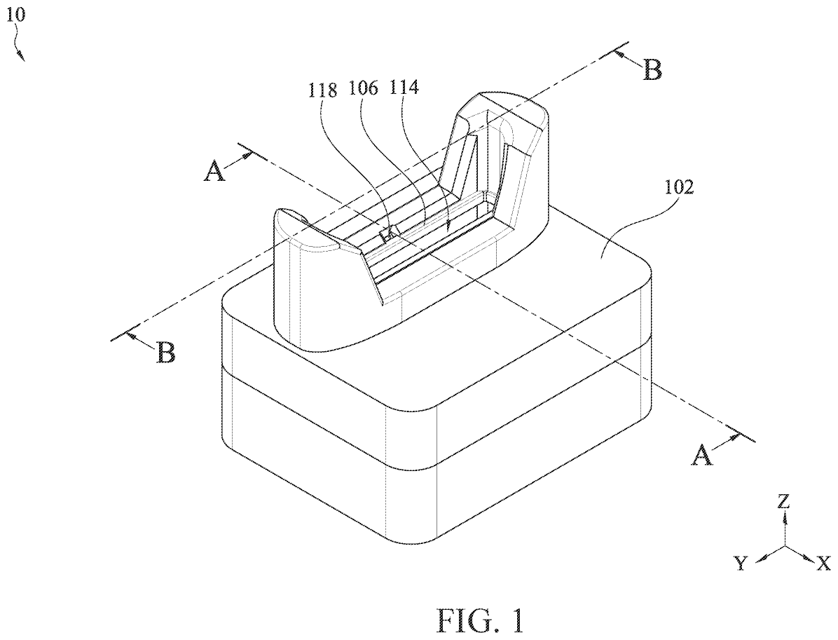

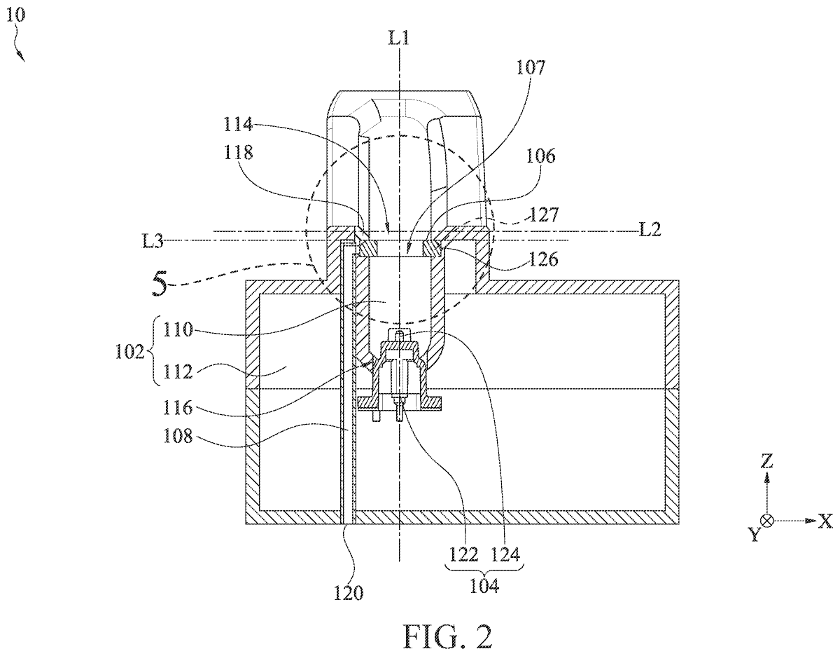

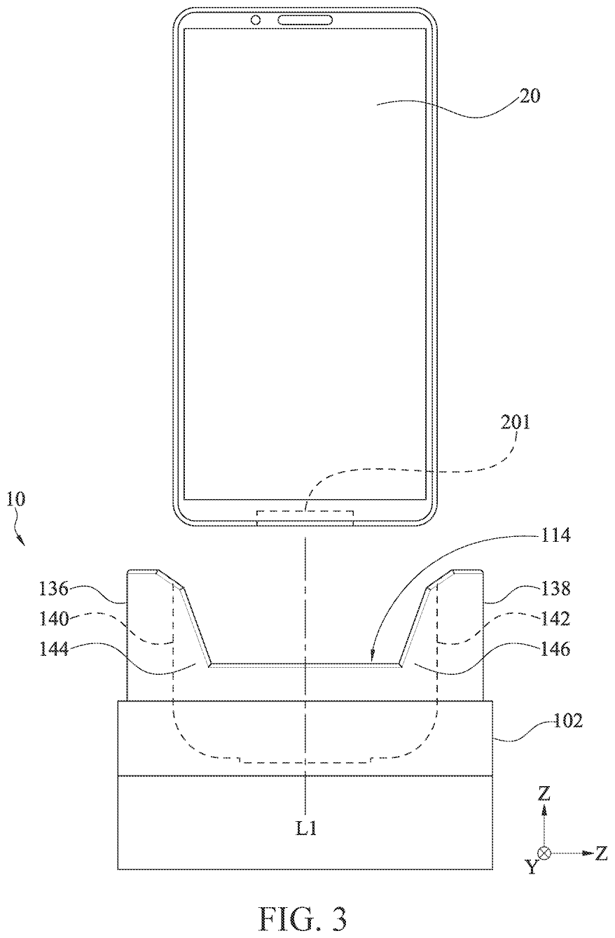

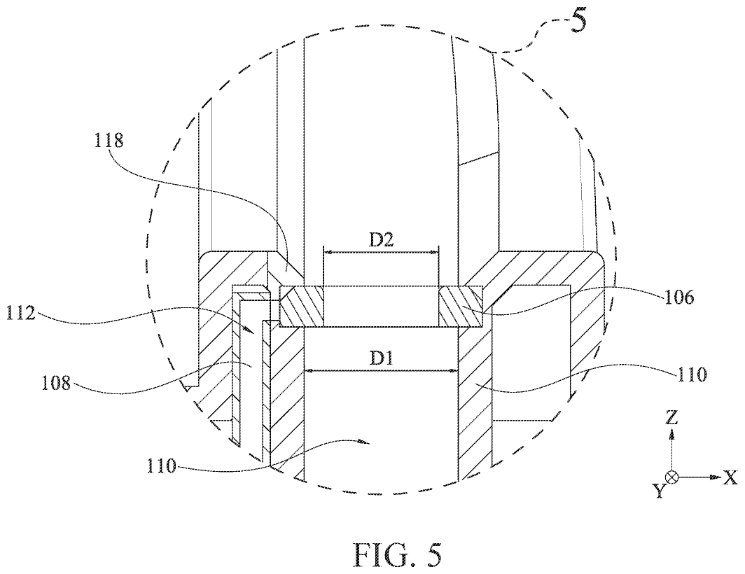

Refer to FIG. 1, FIG. 2, and FIG. 3 together. FIG. 1 is a three-dimensional view of a charging device according to some embodiments of the present invention. FIG. 2 is a cross-sectional view of FIG. 1 in a direction A-A. FIG. 3 is a front view of an electronic device connected to a charging device according to some embodiments of the present invention. As shown in FIG. 1 to FIG. 3, a charging device 10 includes a base 102, a charging assembly 104, a filler 106, and a drain assembly 108. The base 102 includes a charging groove 110 and a receiving groove 112. The charging groove 110 has a first opening 114 and a second opening 116. The first opening 114 has a first through hole 118. The receiving groove 112 has a second through hole 120. The charging assembly 104 is connected to the second opening 116. The filler 106 is connected to an inner side of the first opening 114 and disposed close to the first through hole 118, and the filler 106 has a connecting opening 107. Two ends of the drain assembly 108 are connected to the first through hole 118 and the second through hole 120 respectively. The inner side of the first opening 114 has a first distance, an inner side of the connecting opening 107 has a second distance, and the first distance is greater than the second distance (which is described below in FIG. 5).

As shown in FIG. 2 and FIG. 3, the charging device 10 may charge an electronic device 20. When the electronic device 20 is moved from a low-temperature environment to a normal-temperature environment, a surface of the electronic device 20 is affected by an ambient temperature change, resulting in a water droplet (or water vapor) on the surface of the electronic device 20. The charging device 10 can eliminate the water droplet falling from the electronic device 20 onto the charging device 10, to prevent the water droplet from flowing into the charging groove 110. Therefore, during the charging by the charging device 10, accelerated metal oxidation and a charging failure or abnormality of the charging assembly 104 and the charging portion 201 caused by an electrolysis of an electroplated layer on a surface of the charging assembly 104 and a surface of a charging portion 201 of the electronic device 20 is avoided. In some embodiments, the charging device 10 may be electrically connected to power (for example, mains power or power provided by a power supply) to supply power to the charging assembly 104 and an associated circuit module (which is described below). The electronic device 20 may be, for example, but is not limited to, a mobile phone, a handheld barcode scanner, or a handheld computer.

As shown in FIG. 2 and FIG. 3, the base 102 is configured to be connected to and support the electronic device 20. When the electronic device 20 is connected to the base 102, the charging portion 201 of the electronic device 20 may be coupled to the charging assembly 104 in the charging groove 110, so that the charging assembly 104 can charge the electronic device 20. The receiving groove 112 of the base 102 may receive the charging assembly 104 or an associated circuit module (for example, a circuit board composed of a rectifier circuit, a transformer circuit, and a control circuit). In some embodiments, the charging groove 110 and the receiving groove 112 may be integrally formed, or the charging groove 110 and the receiving groove 112 may be connected to each other. In some embodiments, as shown in FIG. 2, the charging assembly 104 has a plumb line L1. The plumb line L1 may be an axis extending from a center of the charging assembly 104 in a Z-axis direction in FIG. 2. The first opening 114 of the charging groove 110 faces the second opening 116, which may mean that a center of the first opening 114 and a center of the second opening 116 are substantially located on the plumb line L1, or may mean that the second opening 116 is visually accessible from the first opening 114. Therefore, when the electronic device 20 enters the charging groove 110 through the first opening 114 and the connecting opening 107, the electronic device 20 can be substantially coupled to the charging assembly 104 of the second opening 116 along a trajectory of the plumb line L1 (for example, a negative value direction of the Z axis in FIG. 2).

As shown in FIG. 2 and FIG. 3, the charging assembly 104 is connected to the second opening 116 for charging the electronic device 20. In some embodiments, the charging assembly 104 includes a charging connection portion 122. The charging connection portion 122 may be engaged with the charging portion 201 of the electronic device 20. The expression “the charging connection portion 122 is engaged with the charging portion 201” may mean that charging assembly 104 is electrically connected to the electronic device 20, so that the charging assembly 104 charges the electronic device 20. In some embodiments, the charging connection portion 122 may be a connection terminal, an electrode plate, or a wireless charging module. Implementations allowing the charging connection portion 122 to be coupled to the charging portion 201 of the electronic device 20 so that the charging assembly 104 can charge the electronic device 20 may be realized, which are not limited to the connection terminal, the electrode plate, or the wireless charging module. The connection terminal is used as an example. The charging connection portion 122 in FIG. 2 includes at least one connection terminal 124, and the charging portion 201 of the electronic device 20 is a charging hole. When the electronic device 20 is connected to the base 102, the connection terminal 124 may be coupled to the charging portion 201 (the charging hole) to form an electrically conductive state. In some embodiments, the charging assembly 104 may be integrated with the circuit module (for example, a rectifier circuit, a voltage converter circuit, or a control circuit), or the charging assembly 104 may be independent of the circuit module, and the charging assembly 104 is electrically connected to the circuit module through a connecting wire. In some embodiments, the connection terminal 124 is parallel to the plumb line L1. Therefore, after the electronic device 20 enters the charging groove 110 through the first opening 114, the charging portion 201 may be coupled to the connection terminal 124 substantially along the plumb line L1.

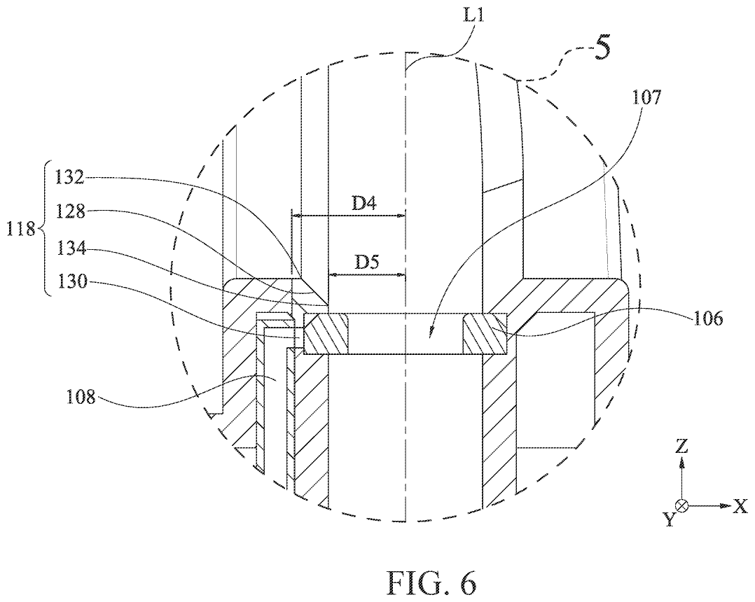

As shown in FIG. 2, the filler 106 may be connected to the inner side of the first opening 114 through bonding or embedding. The filler 106 is elastic and may be made of an elastic material, such as but not limited to a rubber, elastic plastic, or silicone. The filler 106 may correspond to a shape of the first opening 114 and be embedded in the first opening 114 (which is described below). For example, the filler 106 and the first opening 114 may be of the same shape, and the filler 106 may match the shape of the first opening 114 by virtue of characteristics of the elastic material and be fixed to the first opening 114. In some embodiments, the filler 106 may be parallel or not parallel to the first opening 114. As shown in FIG. 2, the filler 106 is parallel to the first opening 114, for example. The first through hole 118 has a horizontal line L2 extending along an X-axis direction in FIG. 2, and the filler 106 has an axis L3 extending along the X-axis direction in FIG. 2. The axis L3 is parallel to the horizontal line L2. Therefore, when the electronic device 20 is connected to the base 102, the filler 106 can be perpendicular to the electronic device 20. In some embodiments, the connecting opening 107 of the filler 106 may be, for example, a slit. The connecting opening 107 may be expanded by an external force. When the electronic device 20 extends through the filler 106 through the connecting opening 107, the electronic device 20 can be tightly caught by the filler 106, and the electronic device 20 is divided into parts such as an embedded part and a part exposed from the charging groove 110 according to positions of the electronic device 20 caught by the filler 106 (as shown in FIG. 2). The horizontal line L2 may be located between an inlet and an outlet of the first through hole 118 (which is described below in FIG. 6), and the axis L3 may be located on a top of the filler 106.

As shown in FIG. 2, in some embodiments, an inner side of the charging groove 110 includes an assembly groove 126, the assembly groove 126 is adjacent to the first through hole 118, and the filler 106 is assembled into the assembly groove 126 and protrudes from the assembly groove 126. In some embodiments, the filler 106 includes a fixing portion 127 (for example, a dashed-line portion of the filler 106 in FIG. 2). The fixing portion 127 may be embedded in the assembly groove 126, so that the filler 106 is fixed to the assembly groove 126. A thickness of the fixing portion 127 (the thickness is a length of the fixing portion 127 in the Z axis in FIG. 2) may be greater than or equal to an embedding length of the assembly groove 126 (the embedding length is a length of the assembly groove 126 in a Z-axis opening in FIG. 2). For example, when the fixing portion 127 is assembled in the assembly groove 126, the fixing portion 127 may be compressed in volume to match a spacing of the assembly groove 126, so that the fixing portion 127 enters and is fixed in the assembly groove 126. The fixing portion 127 may alternatively be coated with a bonding adhesive and then bonded to the assembly groove 126.

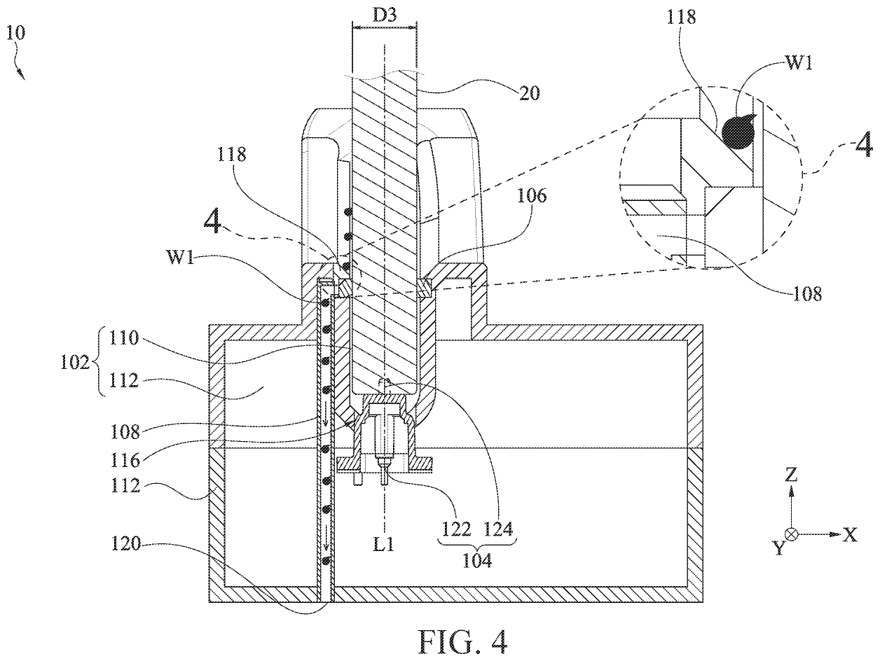

As shown in FIG. 2, the drain assembly 108 is connected to the first through hole 118 and the second through hole 120, so that the first through hole 118 is in communication with the second through hole 120. The first through hole 118 may be a hole, a slot, or an opening extending through the charging groove 110, so that the charging groove 110 is in communication with an end of the drain assembly 108. The second through hole 120 may be a hole, a slot, or an opening extending through the receiving groove 112 (that is, extending to outside of the base 102), so that the drain assembly 108 is in communication with the outer portion of the base 102 to drain a water droplet flowing through the drain assembly 108 (see a water droplet W1 in FIG. 4). In some embodiments, the drain assembly 108 may be a tube body or may be a tunnel-like wall structure formed by the base 102 extending to the first through hole 118 and the second through hole 120.

Referring to FIG. 4, FIG. 4 is a side cross-sectional view of FIG. 1 in the direction A-A, showing a schematic diagram of the electronic device connected to a base. The electronic device 20 in FIG. 4 is coupled to the charging assembly 104. When the part of the electronic device 20 exposed from the charging groove 110 generates a water droplet W1 due to an ambient temperature difference, the water droplet W1 flows to the filler 106 along the surface of the electronic device 20. After the water droplet W1 drops to the filler 106, the water droplet W1 may further flow into the first through hole 118 along the filler 106, which forms a flowing path in the first through hole 118 and the drain assembly 108. Finally, the water droplet W1 can be discharged from the base 102 through the second through hole 120.

Refer to FIG. 4 and FIG. 5 together. FIG. 5 is an enlarged view of a region 5 in FIG. 2, showing a distance between two sides of a first opening and a distance between two sides of a filler. As shown in FIG. 4 and FIG. 5, the inner side of the first opening 114 has a first distance D1, and the inner side of the connecting opening 107 has a second distance D2. The first distance D1 is a length of the inner side of the first opening 114 in an X-axis direction in FIG. 5, and the second distance D2 is a length of the inner side of the connecting opening 107 in the X-axis direction in FIG. 5. The electronic device 20 has a thickness D3, and the thickness D3 is a length of the electronic device 20 in an X-axis direction in FIG. 4. In some embodiments, the first distance D1 is greater than the second distance D2, the thickness D3 of the electronic device 20 is between the first distance D1 and the second distance D2, and the thickness D3 of the electronic device 20 may be substantially equal to the second distance D2. Specifically, when the electronic device 20 enters the base 102 through the first opening 114, since the thickness D3 of the electronic device 20 is less than the first distance D1, a small spacing is defined between the electronic device 20 and two sides of the first opening 114. The electronic device 20 can easily enter a range of the first opening 114 through the spacing. When the electronic device 20 extends through the connecting opening 107, since the thickness D3 of the electronic device 20 is between the first distance D1 and the second distance D2, the connecting opening 107 is expanded by the electronic device 20 when the electronic device 20 enters the connecting opening 107, and extends through the filler 106 in close contact with connecting opening 107. When the electronic device 20 extends through connecting opening 107, the connecting opening 107 may be tightly sleeved around the electronic device 20, so that the connecting opening 107 can retain the water droplet W1 on a side of horizontal line L2 (that is, a side of the horizontal line L2 close to the first through hole 118).

Refer to FIG. 2, FIG. 4, and FIG. 6 together. FIG. 6 is an enlarged view of the region 5 in FIG. 2, showing a schematic diagram of distances of a first endpoint and a second endpoint from a plumb line. In some embodiments, as shown in FIG. 2, FIG. 4, and FIG. 6, the first through hole 118 includes an inlet 128 and an outlet 130. The inlet 128 is located on one side of the horizontal line L2, and the outlet 130 is located on an other side of the horizontal line L2. The above expression “the filler 106 is connected to the inner side of the first opening 114 and disposed close to the first through hole 118” may mean that the filler 106 is adjacent to the inlet 128. In some embodiments, the inlet 128 includes a first endpoint 132 and a second endpoint 134, and the filler 106 is adjacent to the second endpoint 134, which may mean that the axis L3 of the filler 106 is located at the second endpoint 134, or may mean that the axis L3 of the filler 106 is located between the first endpoint 132 and the second endpoint 134. That is to say, the filler 106 shields a part of the inlet 128, and the inlet 128 is still exposed from the filler 106, so that the water droplet W1 can be discharged into the first through hole 118 through the inlet 128. The expression “the drain assembly 108 is connected to the first through hole 118” may mean that the drain assembly 108 is connected to the outlet 130. In addition, according to the Z-axis direction in FIG. 2, the inlet 128 is arranged higher than the outlet 130. Therefore, after entering the first through hole 118 through the inlet 128, the water droplet W1 can flow rapidly toward the outlet 130 and flow into the drain assembly 108 under an action of the natural gravity, which improves the drainage efficiency.

As shown in FIG. 2, FIG. 4, and FIG. 6, in some embodiments, the first endpoint 132 is at a third distance D4 from the plumb line L1, the second endpoint 134 is at a fourth distance D5 from the plumb line L1, and the third distance D4 is greater than or equal to the fourth distance D5. In this way, the first through hole 118 is inclined, which increases a contact area between the first through hole 118 and the water droplet. Specifically, when the water droplet W1 dropping from the electronic device 20 converges to the first through hole 118, the inclined first through hole 118 which has a large drain area helps the water droplet W1 converge into the first through hole 118, thereby improving the drainage efficiency of the first through hole 118.

As shown in FIG. 2 and FIG. 3, in some embodiments, a first partition wall 136 and a second partition wall 138 respectively extend from two ends of the first opening 114, the first partition wall 136 has a first guiding surface 140, the second partition wall 138 has a second guiding surface 142, and the first guiding surface 140 and the second guiding surface 142 respectively face the first opening 114. Specifically, when the electronic device 20 is connected to and faces the base 102, the first partition wall 136 and the second partition wall 138 can provide a limiting effect for the electronic device 20 in a Y-axis direction in FIG. 3. In addition, when the electronic device 20 contacts the first guiding surface 140 or the second guiding surface 142, the first guiding surface 140 or the second guiding surface 142 can guide the electronic device 20 to enter the first opening 114 at a correct angle in the Y-axis direction in FIG. 3. In some embodiments, two sides of the first partition wall 136 each include a first side plate group 144, two sides of the second partition wall 138 each include a second side plate group 146, and the first side plate group 144 and the second side plate group 146 respectively extend along two sides of the first opening 114. Specifically, when the electronic device 20 moves between the first side plate group 144 and the second side plate group 146, the first side plate group 144 and the second side plate group 146 can provide a limiting effect for the electronic device 20 in an X-axis direction in FIG. 3. In addition, the first side plate group 144 and the second side plate group 146 can guide the electronic device 20 to enter the first opening 114 at a correct angle in the X-axis direction in FIG. 3. Based on the above, the base 102 may extend through the first partition wall 136, the second partition wall 138, the first side plate group 144, and the second side plate group 146, so that the charging portion 201 of the electronic device 20 can be connected to the charging connection portion 122 of the charging assembly 104 substantially along the plumb line L1.

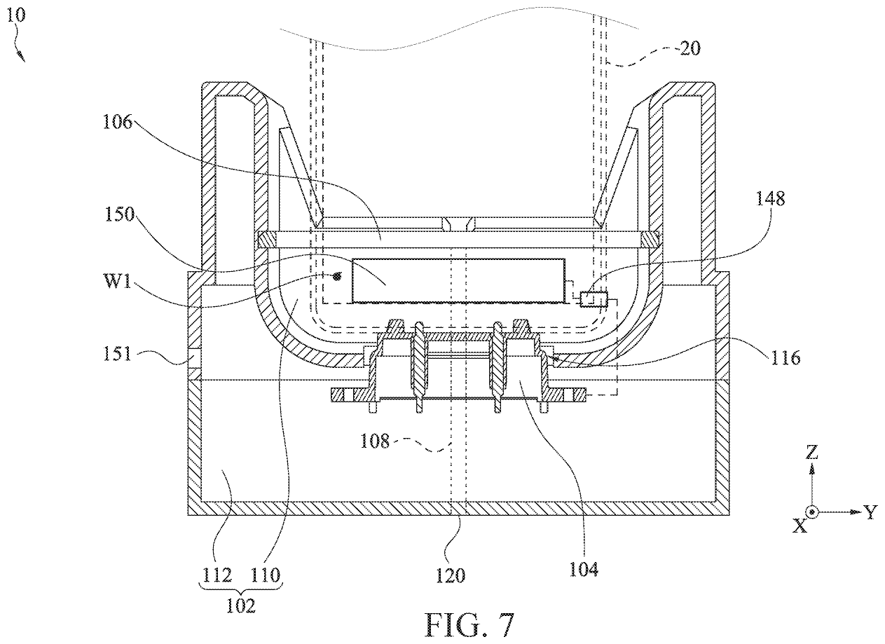

Referring to FIG. 7, FIG. 7 is a cross-sectional view of the electronic device in a direction B-B in FIG. 1 according to some embodiments of the present invention, showing positions of a sensor and a heating assembly in a charging groove. As shown in FIG. 7, in some embodiments, the charging device 10 further includes a sensor 148. The sensor 148 is located between the filler 106 and the second opening 116 and is coupled to the charging assembly 104. The sensor 148 is configured to generate a start signal when sensing a first humidity value and generate an end signal when receiving a second humidity value. The first humidity value may be a relative humidity (RH) of substantially 51% to 80%, and the second humidity value may be an RH of substantially 30% to 50%. The sensor 148 may be, for example, but is not limited to, a humidity sensor (for example, a humidity sensitive resistor or a humidity sensitive capacitor). The sensor 148 may sense a humidity of an internal environment of the charging groove 110. Specifically, the internal environment of the charging groove 110 may be a space from the filler 106 to the second opening 116. The sensor 148 may continuously detect the humidity after the charging assembly 104 is connected to the power supply.

As shown in FIG. 7, when the sensor 148 senses that an ambient humidity is greater than or equal to the first humidity value, the sensor 148 may transmit a start signal, so that the charging assembly 104 may stop charging of the electronic device 20 according to the start signal. When the sensor 148 detects that the ambient humidity is equal to or less than the second humidity value (for example, the RH is equal to or less than 50%), the sensor 148 may transmit an end signal, so that the charging assembly 104 may resume charging of the electronic device 20 (or actuating the charging assembly 104) according to the end signal. For example, before the electronic device 20 is connected to the base 102, when the ambient humidity in the charging groove 110 is less than or equal to the second humidity value, the sensor 148 may transmit the end signal. The end signal can actuate the charging assembly 104. When the electronic device 20 is connected to the base 102, the part of the electronic device 20 embedded in the charging groove 110 gradually generates a water droplets W1 (or water vapor) due to a temperature difference. The sensor 148 can sense a gradual humidity increase inside the charging groove 110. When the internal humidity of the charging groove 110 increases to be greater than or equal to the first humidity value (for example, the RH is greater than or equal to 51%), the sensor 148 may generate the start signal according to the first humidity value. The start signal can stop the charging operation of the charging assembly 104 to avoid charging of the connection terminal 124 in a high humidity environment, thus protecting a surface coating of the connection terminal 124. When the internal humidity of the charging groove 110 decreases to the second humidity value, the sensor 148 may generate the end signal according to the second humidity value, so that the charging assembly 104 can resume the charging according to the end signal (which is described below).

As shown in FIG. 7, in some embodiments, the charging device 10 further includes a heating assembly 150. The heating assembly 150 is located between the filler 106 and the second opening 116 and is coupled to the sensor 148. The charging groove 110 is configured to perform a heating action according to the start signal and to stop the heating action according to the end signal. The heating assembly 150 may be, for example, but is not limited to, one or a combination of two of the following heating assemblies 150: a heating sheet (such as a mica heating sheet, a silicone heating sheet, a ceramic heating sheet, a metal heating sheet, or an etched heating sheet), a heating film, a heating wire, or a thermistor. Specifically, when the sensor 148 senses that the humidity of the internal environment of the charging groove 110 is greater than or equal to the first humidity value, which means that the humidity of the environment is excessively high and may cause an electrolytic reaction on the coating on the surface of the connection terminal 124 or on the surface of the charging portion 201, the sensor 148 transmits the start signal, so that the heating assembly 150 may perform a heating action according to the start signal, to reduce the humidity of the internal environment by increasing the temperature of the internal environment of the charging groove 110. When the humidity of the internal environment is equal to or less than the second humidity value, it means that the humidity of the environment no longer causes the electrolytic reaction. In this case, the sensor 148 transmits the end signal, so that the heating assembly 150 may stop the heating action according to the end signal. When the sensor 148 transmits a next start signal, the heating assembly 150 performs the heating action again. In some embodiments, the receiving groove 112 further a vent hole 151. The vent hole 151 is in communication with inside of the receiving groove 112 and outside of the base 102. When the heating assembly 150 performs the heating action according to the start signal, the water in the charging groove 110 evaporates into water vapor. The water vapor can flow to the receiving groove 112 through an assembly gap between the sensor 148 (or the heating assembly 150) and the charging groove 110, and is finally discharged to the outside of the base 102 through the vent hole 151.

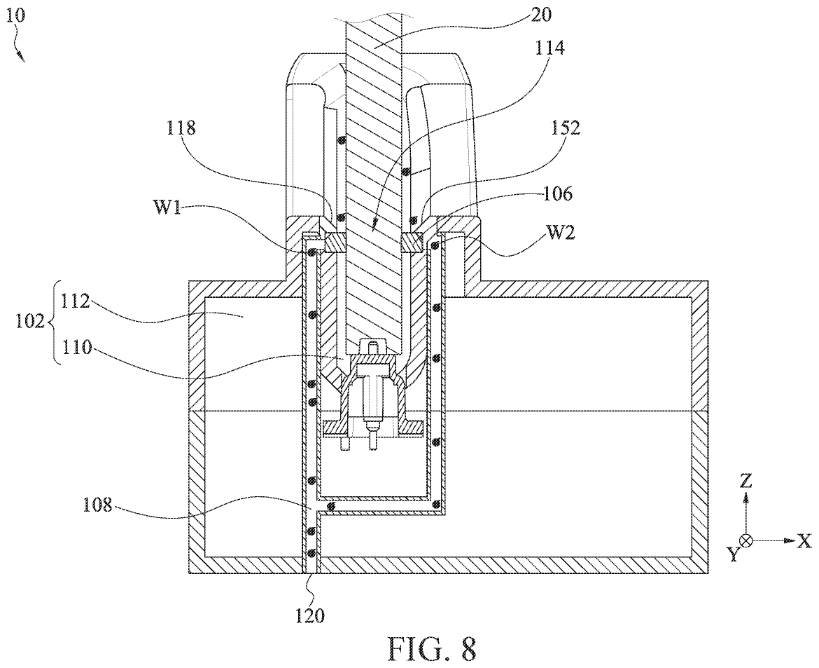

Referring to FIG. 8, FIG. 8 is a cross-sectional view of the charging device in the direction A-A in FIG. 1 according to some embodiments of the present invention, showing relatives position of a first through hole and a third through hole. As shown in FIG. 8, in some embodiments, the first opening 114 has a third through hole 152, the third through hole 152 is located on an opposite side of the first through hole 118, one end of the drain assembly 108 is connected to the first through hole 118 and the third through hole 152, and an other end is connected to the second through hole 120. Specifically, after the electronic device 20 is connected to the base 102, water droplets (W1 and W2) in FIG. 8 drop toward the filler 106 along two sides of the electronic device 20. The water droplet W1 is discharged into the drain assembly 108 through the first through hole 118, and the water droplet W2 is discharged into the drain assembly 108 through the third through hole 152. Finally, the water droplets (W1 and W2) are discharged from the base 102 through the second through hole 120 by the drain assembly 108. It should be noted that in this embodiment, the drain assembly 108 may be a connecting pipe, so that the drain assembly 108 can be connected to the first through hole 118, the second through hole 120, and the third through hole 152.

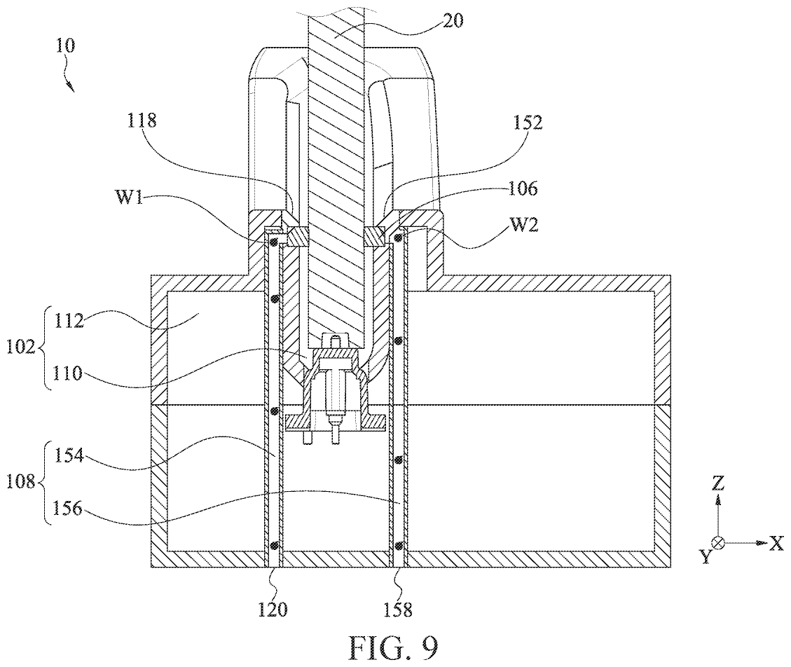

Referring to FIG. 9, FIG. 9 is a cross-sectional view of the charging device in the direction A-A in FIG. 1 according to some embodiments of the present invention, showing relative positions of a first drain unit and a second drain unit. As shown in FIG. 9, the drain assembly 108 includes a first drain unit 154 and a second drain unit 156. The receiving groove 112 includes a fifth through hole 158. One end of the first drain unit 154 is connected to the first through hole 118, and an other end is connected to the second through hole 120. One end of the second drain unit 156 is connected to the third through hole 152, and an other end is connected to the fifth through hole 158. Specifically, the first drain unit 154 is not in communication with the second drain unit 156. It should be noted that in this embodiment, the second through hole 120 and the fifth through hole 158 are arranged on a bottom of the receiving groove 112, or may be arranged on a side of the receiving groove 112. This embodiment does not limit the positions of the second through hole 120 and the fifth through hole 158.

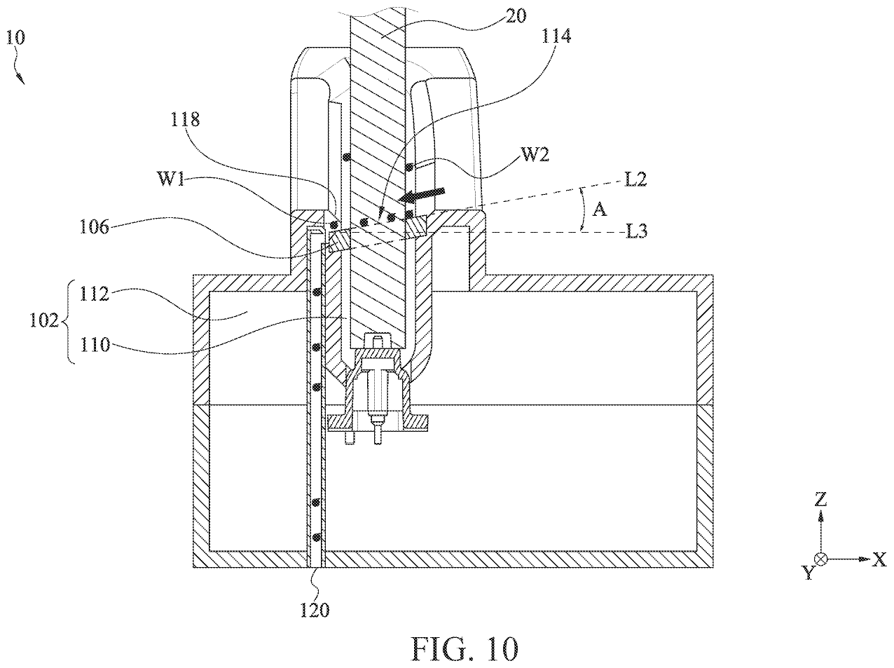

Referring to FIG. 10, FIG. 10 is a cross-sectional view of the charging device in the direction A-A in FIG. 1 according to some embodiments of the present invention, showing an included angle between an axis and a horizontal line. As shown in FIG. 10, in some embodiments, the filler 106 may be inclinedly arranged on the inner side of the first opening 114. Specifically, the axis L3 intersects and forms an included angle A with the horizontal line L2, and a side of the filler 106 is adjacent to the first through hole 118. The included angle A may be an acute Angle. The included angle A may range from 5 degrees to 30 degrees, and preferably, is 15 degrees. For example, the included angle A is 15 degrees. Since an inclination angle of the filler 106 is 15 degrees, the filler 106 can maintain a desirable tightness with the charging device 10, so that the filler 106 can guide the water droplets (W1 and W2) to flow into the first through hole 118. For example, when the water droplets (W1 and W2) on the two sides of the electronic device 20 drop onto the filler 106, the water droplet W2 can flow to a side of the filler 106 adjacent to the first through hole 118 from a side away from the first through hole 118 and converge into the first through hole 118 by virtue of a slope of the filler 106.

Based on the above, in some embodiments of the present invention, a charging device 10 is provided. Through the filler 106 and the first through hole 118 located in the charging groove 110, the water droplets (W1 and W2) can be prevented from flowing to the charging assembly 104 by the filler 106, and the filler 106 can guide the water droplets (W1 and W2) to flow to the first through hole 118 and be discharged outside of the base 102 of the charging device 10 through the second through hole 120, which ensures that the charging assembly 104 does not contact the water droplets (W1 and W2), thereby maintaining normal charging of the charging assembly 104.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A charging device, comprising:
a base, comprising a charging groove and a receiving groove, wherein the charging groove has a first opening and a second opening, the first opening has a first through hole, and the receiving groove has a second through hole;
a charging assembly, connected to the second opening;
a filler, connected to an inner side of the first opening and disposed close to the first through hole, wherein the filler has a connecting opening; and
a drain assembly, wherein two ends of the drain assembly are connected to the first through hole and the second through hole respectively; and
the inner side of the first opening has a first distance, an inner side of the connecting opening has a second distance, and the first distance is greater than the second distance.

2. The charging device according to claim 1, wherein the first through hole has a horizontal line, and the filler has an axis parallel to the horizontal line.

3. The charging device according to claim 2, wherein the first through hole comprises an inlet and an outlet, the inlet is located on one side of the horizontal line, and the outlet is located on an other side of the horizontal line.

4. The charging device according to claim 3, wherein the inlet comprises a first endpoint and a second endpoint, and the filler is adjacent to the second endpoint.

5. The charging device according to claim 4, wherein a center of the charging assembly comprises a plumb line, the first endpoint is at a third distance from the plumb line, the second endpoint is at a fourth distance from the plumb line, and the third distance is greater than or equal to the fourth distance.

6. The charging device according to claim 1, wherein an inner side of the charging groove comprises an assembly groove, the assembly groove is adjacent to the first through hole, and the filler is assembled into the assembly groove and protrudes from the assembly groove.

7. The charging device according to claim 1, further comprising a sensor, wherein the sensor is arranged between the filler and the second opening and coupled to the charging assembly, and is configured to generate a start signal when sensing a first humidity value and generate an end signal when sensing a second humidity valued; and
the charging assembly is configured to stop charging according to the start signal and to resume charging according to the end signal.

8. The charging device according to claim 7, further comprising a heating assembly, wherein the heating assembly is arranged between the filler and the second opening and coupled to the sensor, and is configured to perform a heating action according to the start signal and to stop the heating action according to the end signal.

9. The charging device according to claim 1, wherein a first partition wall and a second partition wall respectively extend from two ends of the first opening, the first partition wall has a first guiding surface, the second partition wall has a second guiding surface, and the first guiding surface and the second guiding surface respectively face the first opening.

10. The charging device according to claim 9, wherein two sides of the first partition wall each comprise a first side plate group, two sides of the second partition wall each comprise a second side plate group, and the first side plate group and the second side plate group respectively extend along two sides of the first opening.

11. The charging device according to claim 1, wherein the first opening has a third through hole, the third through hole is located on an opposite side of the first through hole, one end of the drain assembly is connected to the first through hole and the third through hole, and an other end is connected to the second through hole.

12. The charging device according to claim 11, wherein the drain assembly comprises a first drain unit and a second drain unit, the receiving groove comprises a fifth through hole, one end of the first drain unit is connected to the first through hole, an other end is connected to the second through hole, one end of the second drain unit is connected to the third through hole, and an other end is connected to the fifth through hole.

13. The charging device according to claim 1, wherein the first through hole has a horizontal line, the filler has an axis parallel to the horizontal line, the axis intersects and forms an included angle with the horizontal line, a side of the filler is adjacent to the first through hole, and the included angle is an acute angle.

14. The charging device according to claim 13, wherein the first through hole comprises an inlet and an outlet, the inlet is located on one side of the horizontal line, and the outlet is located on an other side of the horizontal line.

15. The charging device according to claim 14, wherein the inlet comprises a first endpoint and a second endpoint, and the filler is adjacent to the second endpoint.

16. The charging device according to claim 15, wherein a center of the charging assembly comprises a plumb line, the first endpoint is at a third distance from the plumb line, the second endpoint is at a fourth distance from the plumb line, and the third distance is greater than or equal to the fourth distance.

17. The charging device according to claim 13, further comprising a sensor, wherein the sensor is arranged between the filler and the second opening and coupled to the charging assembly, and is configured to generate a start signal when sensing a first humidity value and generate an end signal when sensing a second humidity valued; and
the charging assembly is configured to stop charging according to the start signal and to resume charging according to the end signal.

18. The charging device according to claim 17, further comprising a heating assembly, wherein the heating assembly is arranged between the filler and the second opening and coupled to the sensor, and is configured to perform a heating action according to the start signal and to stop the heating action according to the end signal.

19. The charging device according to claim 13, wherein a first partition wall and a second partition wall respectively extend from two ends of the first opening, the first partition wall has a first guiding surface, the second partition wall has a second guiding surface, and the first guiding surface and the second guiding surface respectively face the first opening; and
two sides of the first partition wall each comprise a first side plate group, two sides of the second partition wall each comprise a second side plate group, and the first side plate group and the second side plate group respectively extend along two sides of the first opening.

20. The charging device according to claim 13, wherein the first opening has a third through hole, the third through hole is located on an opposite side of the first through hole, one end of the drain assembly is connected to the first through hole and the third through hole, and an other end is connected to the second through hole; and
the drain assembly comprises a first drain unit and a second drain unit, the receiving groove comprises a fifth through hole, one end of the first drain unit is connected to the first through hole, an other end is connected to the second through hole, one end of the second drain unit is connected to the third through hole, and an other end is connected to the fifth through hole.
